(19) United States
(12) Patent Application Publication
(10) Pub. No.: US 2025/0296662 A1
(43) Pub. Date: Sep. 25, 2025

(54) CHANNEL MARKER

(71) Applicant: LUMINSEA, LLC, Miami, FL (US)

(72) Inventor: John Ruiz, Coral Gables, FL (US)

(21) Appl. No.: 18/661,254

(22) Filed: May 10, 2024

Related U.S. Application Data
(63) Continuation-in-part of application No. 17/347,681, filed on Jun. 15, 2021, now abandoned.

(51) Int. Cl. B63B 22/16; G08B 5/00

(52) U.S. Cl. CPC B63B 22/166; G08B 5/00

(57) ABSTRACT

An inventive channel marker includes a least a buoyant member, a display device, a photovoltaic cell and power storage assembly, and a display device connected to a wireless communication system. The inventive channel marker may also be inflatable. Accordingly, the inventive channel marker facilitates its deployment as a temporary channel marker that can be easily stowed when not in use, and with a display that can be configured on the fly to present any desired information.

### PRIORITY CLAIM

This application claims the domestic benefit to, and is a continuation-in-part pursuant to 35 U.S.C. § 120 of, currently pending U.S. application Ser. No. 17/347,681 which was filed on Jun. 15, 2021, the entirety of which is expressly incorporated herein by reference.

### FIELD OF THE INVENTION

The present disclosure relates to channel markers for marking navigational routes along waterways.

### DESCRIPTION OF THE RELATED ART

Channel markers are typically used to indicate preferred channels of travel along waterways, to help vessels avoid underwater hazards or sensitive ecosystems, and generally otherwise maintain marine traffic within desired boundaries. A convention has been established whereby particular shapes, colors, and numbering indicate which side of the marker a vessel should travel along, and to also indicate whether a vessel is traveling toward open water or toward an inland waterway. In this regard, static markers have been preferred, which generally consist of signage (of the appropriate color and shape) affixed to a pylon which is driven into the bed. Channel markers may also be employed on a buoy, but these are typically reserved for locations where a pylon is impractical, such as where the water is too deep to practically drive a pylon. Therefore, these types of buoys are also typically built as permanent or semi-permanent installations such as from metal. This requires the buoy to be rigid, large, and sometimes quite heavy. They are also affixed to the sea floor in a permanent or semi-permanent fashion.

There is therefore a need in the art for a channel marker which lends itself to more temporary use, and thus is more efficient to deploy and collect. In one aspect, the need presents itself in the design of a more portable channel marker. However, problems still persist with the need to comply with numbering conventions on such temporary channel markers. It is inefficient to prepare the desired number of channel markers with pre-determined and static numbers ahead of their deployment. Therefore, there is a need in the art for channel markers with dynamic numbering displays that can be set on an as-need basis, or before, during, or after deployment. The present invention meets these and other needs present in the art.

### SUMMARY OF THE INVENTION

In at least one embodiment, the inventive channel marker includes several features that make it particularly suitable for temporary placement in waterways, such as to mark a race course or to mark temporary travel channels. As such, the channel marker may include a buoyant member that is inflatable for convenient stowage, deployment, and removal. Otherwise, the buoyant member should be constructed from buoyant materials. In a preferred embodiment, the buoyant member is large enough to be easily visible from a predetermined distance, buoyant enough to maintain a display device at a predetermined height above water, and may also be formed in a plurality of shapes and colors, such as a red triangle or a green square.

Typical channel markers include sequential numbers on their faces which serve as navigation aids, generally indicating whether boaters are heading toward open water or toward inland waterways. However, in light of the fact that the inventive channel marker may be used as a temporary marker, it is desirable for it to include a changeable display that can be remotely programmed to indicate any desired information. As such, in a preferred embodiment, the inventive channel marker may include a wireless communication system configured to receive wireless inputs and control the output display in accordance with the received inputs. This permits the inventive channel marker to be programmed to display any relevant information either before, during, or after deployment in water.

Accordingly, in a most preferred embodiment, the wireless communication system is equipped to communicate on any of a plurality of standard protocols, such as via cellular telephone networks, ad-hoc Wi-Fi networks, Bluetooth®, or other appropriate low-power, wide-area protocols for radio frequency communication such as LoRaWAN®. The wireless communication system should also be configured to communicate with at least one client device, either directly or via at least one intermediate device (such as a network server). The client device, most preferably, is a cellular telephone or other mobile device that is configured to operate a web application or a dedicated software application and which contains a user interface that permits a user to program the output display of each channel marker.

In a most preferred embodiment, the inventive channel marker is made from polyvinyl chloride sheet material in the range of about six thousandths (0.006) of an inch in thickness and including a valve for inflation and deflation. The inventive channel marker also includes at least one, but also preferably two displays, power storage, a power generator, a computerized control system, and a wireless communication system. The power storage may comprise a battery or capacitor. The power generator may comprise photocells. The power generator may also comprise a linear induction generator in order to take advantage of wave motion.

These and other objects, features and advantages of the present invention will become clearer when the drawings as well as the detailed description are taken into consideration.

### BRIEF DESCRIPTION OF THE DRAWINGS

For a fuller understanding of the nature of the present invention, reference should be had to the following detailed description taken in connection with the accompanying drawings in which:

FIG. 1 is a front view of two embodiments of the inventive channel marker.

FIG. 2 is a rear view of two embodiments of the inventive channel marker.

FIG. 3 is a side from of two embodiments of the inventive channel marker.

FIG. 4 is a cross-sectional view of the embodiment shown in FIG. 3 taken along line 4-4.

FIG. 5 is a schematic view of various components of the inventive channel marker according to one embodiment of the invention.

Like reference numerals refer to like parts throughout the several views of the drawings.

### DETAILED DESCRIPTION OF THE PREFERRED EMBODIMENT

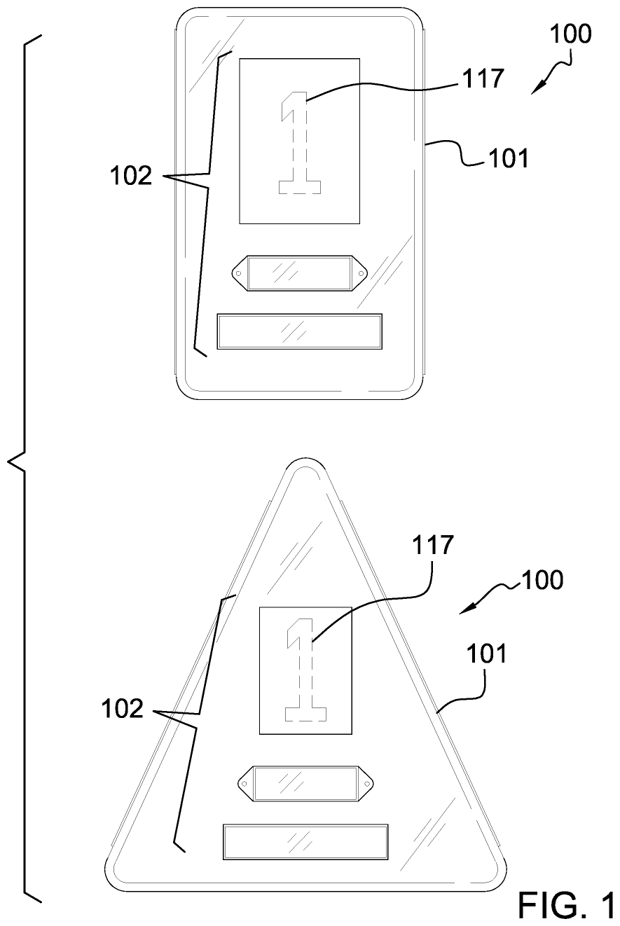

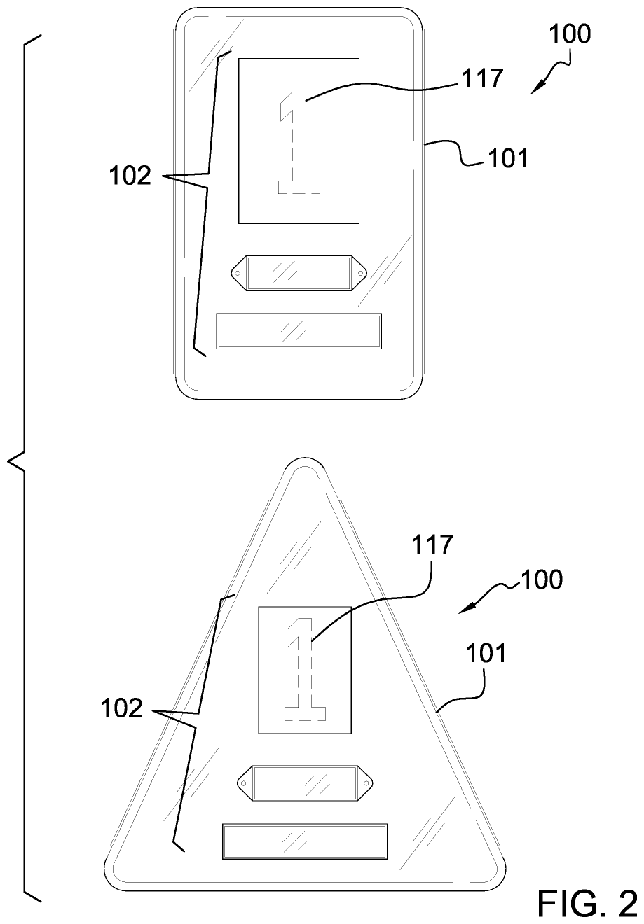

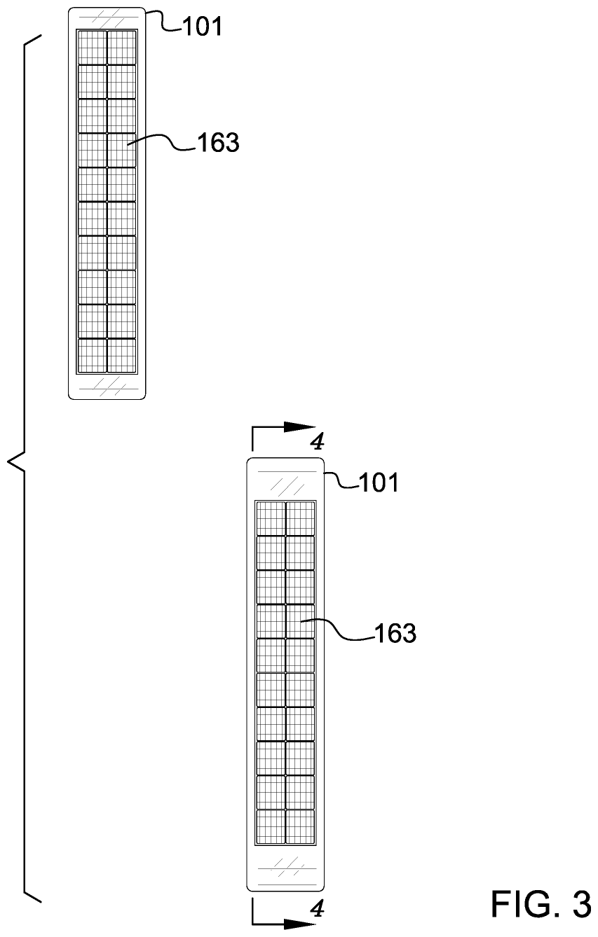

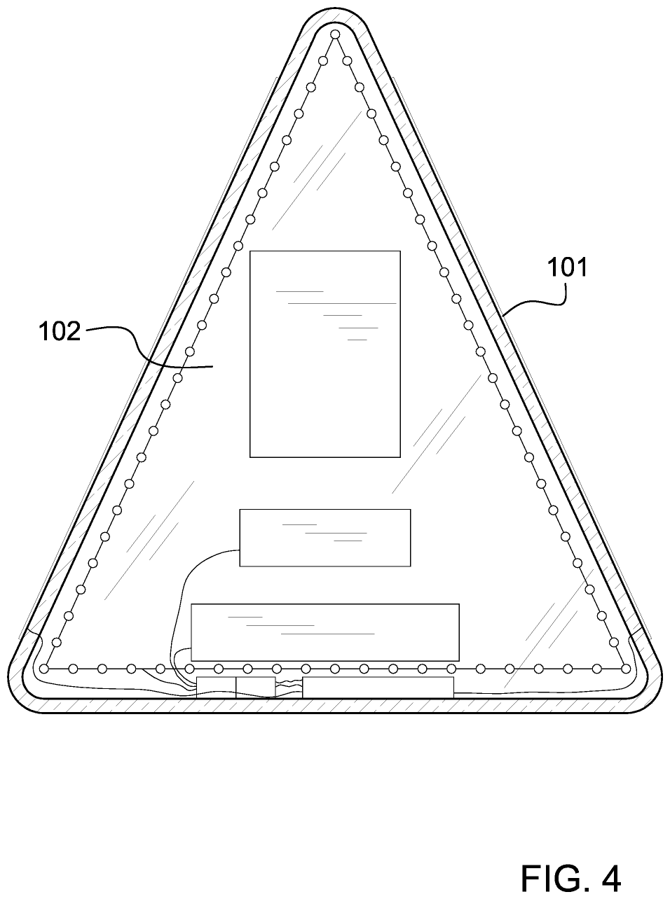

With regard to FIGS. 1-4 generally, the channel marker 100 (hereinafter invention) may be deployed as a navigational aid that visibly marks a geographic location and is part of a larger structure used to mark a path through navigable waters. The invention 100 may comprise a buoy 101, a control circuit 102, and a supervisory structure 103. The control circuit 102 mounts in the buoy 101. The supervisory authority controls the operation of the control circuit 102. The buoy 101 may be made from a buoyant structure. The control circuit 102 controls the various functions of the invention 100, such as illuminating the buoy 101 in periods of darkness and displaying information that uniquely identifies the buoy 101. The supervisory authority determines the appropriate unique identification information displayed by the buoy 101 and remotely changes the unique identification information displayed by the buoy 101 when necessary.

Preferably, the buoy 101 elevates the control circuit 102 above the water such that the unique identification information of the buoy 101 is clearly visible. The supervisory structure 103 establishes a wireless communication link 116 between the control circuit 102 and an appropriate authority 132. The supervisory structure 103 also controls the operation of the control circuit 102. The supervisory structure 103 transmits and changes the unique identification information of the buoy 101 that is displayed by the supervisory structure 103. In one embodiment, the supervisory structure 103 may comprise a commercially provided and publicly available cellular wireless network 131 and an appropriate authority 132. The commercially provided and publicly available cellular wireless network 131 is a communication structure that exchanges messages between the control circuit 102 and the appropriate authority 132. The appropriate authority 132 is an individual or organization that has the responsibility for the operation of the channel marker 100 and/or the displayed image 117.

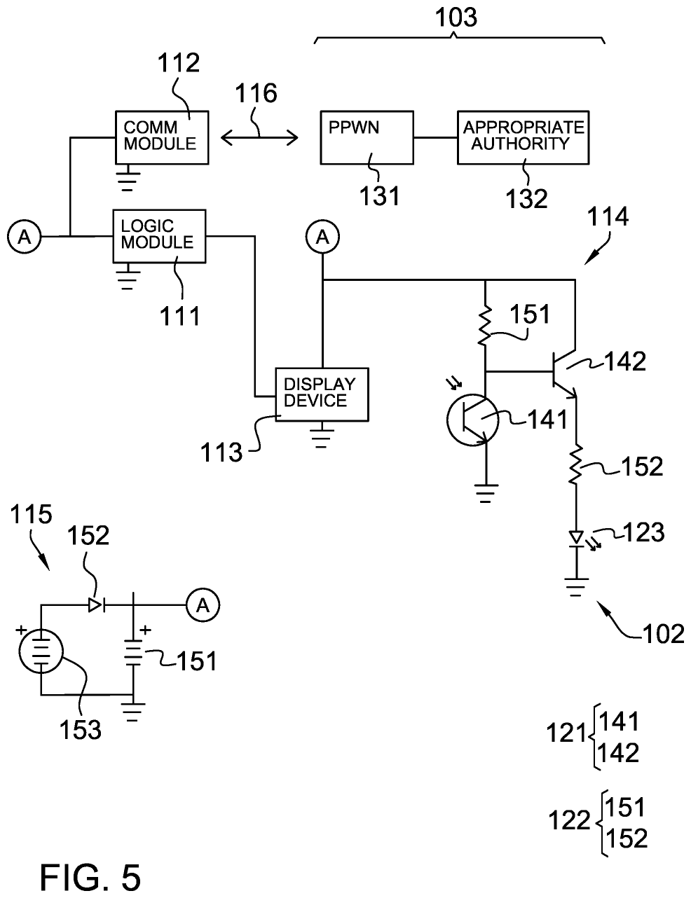

Turning now to FIG. 5 specifically, one embodiment of the operative electronic circuitry of the present invention is disclosed. The control circuit 102 generates an illumination that illuminates the buoy 101 such that the control circuit 102 illuminates the buoy 101 in darkness. The control circuit 102 visibly displays the unique identification information of the buoy 101 such that the unique identification information of the buoy 101 is visible in darkness. The control circuit 102 forms a wireless communication link 116 with the supervisory structure 103. The control circuit 102 receives the unique identification information of the buoy 101 from the supervisory structure 103. The control circuit 102 updates the unique identification information of the buoy 101 when a change to the unique identification information of the buoy 101 is made and transmitted to the control circuit 102 by the supervisory structure 103. In a preferred embodiment, the control circuit 102 may comprise a logic module 111, a communication module 112, a display device 113, a lamp circuit 114, and a power circuit 115. The logic module 111, the communication module 112, the display device 113, the lamp circuit 114, and the power circuit 115 are electrically interconnected. The communication module 112 further comprises a wireless communication link 116. The communication module 112 establishes the wireless communication link 116 with the supervisory structure 103. In a preferred embodiment, the logic module 111 may comprise a readily and commercially available programmable electronic device that is used to manage, regulate, and operate the control circuit 102. The communication module 112 is a wireless electronic communication device that allows the logic module 111 to wirelessly communicate with the supervisory structure 103. The logic module 111 controls the image that is displayed on the display device 113. The logic module 111 creates the displayed image 117. The logic module 111 transmits the displayed image 117 to the display device 113 for display.

In an embodiment where the communication module 112 relies on a cellular wireless network 131, the communication module 112 communicates SMS and/or MMS messages between the logic module 111 and the appropriate authority 132 using the wireless communication link 116. The use of a commercially provided and publicly available cellular wireless network 131 is preferred because of its low cost, of the widespread availability and the broad interoperability between competing commercially provided and publicly available cellular wireless networks 131, and, methods and techniques to send SMS and MMS messages over a commercially provided and publicly available cellular wireless network 131 are well known and documented by those skilled in the electrical arts.

The display device 113 may comprise an electronic or electro-mechanical device such as a seven-segment display, dot matrix display, LED or LCD screen, and the like. The display device 113 may also be an illuminated device or may be fluorescent or phosphorescent. The display device 113 further comprises a displayed image 117. The display device 113 visibly displays the displayed image 117. The logic module 111 controls the operation of the display device 113 by providing the electrical signals used by the display device 113 to generate the displayed image 117, and changing the displayed image 117 presented by the display device 113 when the supervisory structure 103 changes the information to be displayed on the buoy 101. In one embodiment of the disclosure, the image presented as the displayed image 117 presents indicia that generates a sentiment that communicates the unique identification information of the buoy 101. The lamp circuit 114 is an electric circuit. In a most preferred embodiment, when the lamp circuit 114 detects that the buoy 101 is in darkness, the lamp circuit 114 generates an illumination that illuminates the buoy 101 such that the buoy 101 is visible in the darkness in addition to the displayed image 117. The lamp circuit 114 may comprise a plurality of transistors 121, a plurality of limit resistors 122, and a plurality of LEDs 123. The plurality of transistors 121, the plurality of limit resistors 122, and the plurality of LEDs 123 are electrically interconnected.

In the described embodiment, each of the plurality of transistors 121 is a switching element. The plurality of transistors 121 forms a logic circuit that detects when the buoy 101 is in darkness, illuminates the plurality of LEDs 123 when the buoy 101 is in darkness, and extinguishes the plurality of LEDs 123 when the logic circuit detects that the buoy 101 is not in darkness. The plurality of transistors 121 may comprise a phototransistor 141 and a transistor 142. The phototransistor 141 is a photoelectric device which operates as a switch. When light is applied to the phototransistor 141, the phototransistor 141 will act like a closed switch allowing current flow from a collector to an emitter. When light is removed from the phototransistor 141, the phototransistor 141 will act like an open switch prohibiting current flow from the collector to the emitter of the phototransistor 141. The phototransistor 141 electrically connects to the transistor 142 such that the transistor 142 actuates to a closed position when the phototransistor 141 detects that the buoy 101 is in darkness and actuates to an open position when the phototransistor 141 detects that the buoy 101 is not in darkness.

The transistor 142 controls the flow of electricity from the power circuit 115 into the plurality of LEDs 123. The transistor 142 actuates to a closed position to illuminate the plurality of LEDs 123. The transistor 142 actuates to an open position to extinguish the illumination generated by the plurality of LEDs 123. Each of the plurality of limit resistors 122 is a resistor. Each of the plurality of limit resistors 122 is used to control the flow of electric current through the lamp circuit 114. The plurality of limit resistors 122 comprises a first limit resistor 151 and a second limit resistor 152. The first limit resistor 151 electrically connects in series with the phototransistor 141 such that the first limit resistor 151 limits the amount of electric current flowing through the phototransistor 141. The second limit resistor 152 is an electric circuit element. The second limit resistor 152 electrically connects in series with the plurality of LEDs 123 such that the second limit resistor 152 limits the amount of electric current flowing through the plurality of LEDs 123. The plurality of transistors 121 controls the operation of each of the plurality of LEDs 123 by controlling the flow of electric current through the plurality of LEDs 123. The plurality of LEDs 123 generates the illumination necessary to illuminate the buoy 101 in darkness.

The power circuit 115 provides electricity to the control circuit 102 and in a preferred embodiment comprises a battery 161, a diode 162, and a photovoltaic cell 163. The battery 161, the diode 162, and the photovoltaic cell 163 are electrically interconnected. The battery 161 converts chemical potential energy into the electrical energy used to power the control circuit 102. The photovoltaic cell 163 is an electrical device that converts electromagnetic radiation, such as sunlight, into electrical energy. The chemical energy stored within the rechargeable battery 161 is further renewed and restored through the use of the photovoltaic cell 163. The photovoltaic cell 163 provides the energy necessary to charge the battery 161. The diode 162 is an electrical device that allows current to flow in only one direction. The diode 162 is installed between the rechargeable battery 161 and the photovoltaic cell 163 to restrict the flow of electricity from the battery 161 to the photovoltaic cell 163.

Since many modifications, variations and changes in detail can be made to the described embodiments of the invention, it is intended that all matters in the foregoing description and shown in the accompanying drawings be interpreted as illustrative and not in a limiting sense. Thus, the scope of the invention should be determined by the appended claims and their legal equivalents.

What is claimed is:

1. A channel marker comprising:
a buoyant member and a control circuit, the control circuit including at least a logic module, a communication module, a display device, and a power circuit;
said power circuit comprising at least a battery and a photovoltaic cell, and is configured to permit said photovoltaic cell to charge said battery, said battery being disposed in electrically powering relation to said control circuit; and
said logic module being disposed in electrical communication with said communication module and said display device, and further configured to receive signals from said communication module and to generate a displayed image on said display device.

2. The channel marker as recited in claim 1 wherein said buoyant member is triangular.

3. The channel marker as recited in claim 2 wherein said buoyant member is red.

4. The channel marker as recited in claim 1 wherein said buoyant member is square.

5. The channel marker as recited in claim 4 wherein said buoyant member is green.

6. The channel marker as recited in claim 1 wherein said displayed image conveys one of a geographic location and a distance.

7. The channel marker as recited in claim 1 wherein said displayed image uniquely identifies the channel marker from among a plurality of channel markers.

8. The channel marker as recited in claim 1 wherein said communication module further comprises a wireless communication link.

9. The channel marker as recited in claim 8 wherein said control circuit is configured to receive signals via said wireless communication link.

10. The channel marker as recited in claim 9 wherein said logic circuit is configured to generate a displayed image on said display device in response to receiving said signals via said wireless communication link.

11. The channel marker as recited in claim 1 wherein said logic module is a programmable electronic device.

12. The channel marker as recited in claim 1 wherein said communication module is a wireless communication device configured to receive at least one of SMS and MMS messages via a cellular network using a wireless communication link.

13. The channel marker as recited in claim wherein said communication module is a wireless communication device configured to receive signals via a predetermined protocol for radio frequency communications.

14. The channel marker as recited in claim 1 further comprising a lamp circuit.

15. The channel marker as recited in claim 14 wherein said lamp circuit includes at least one phototransistor and at least on lighting element.

16. The channel marker as recited in claim 15 wherein said phototransistor is configured to illuminate the channel marker with said lighting element upon detecting that the channel marker is in darkness.
